(19) United States
(12) Patent Application Publication
(10) Pub. No.: US 2026/0310459 A1
(43) Pub. Date: Oct. 8, 2026

(54) PROVISIONING OF SOFTWARE DOCUMENTATION BASED ON TARGET USER

(71) Applicant: Dell Products L.P., Round Rock, TX (US)

(72) Inventors: REUT KOVETZ, Tel Aviv (IL); SHELLY GOLDBLIT, Haifa (IL); OFIR EZRIELEV, Be'er Sheva (IL); JEHUDA SHEMER, Kfar Saba (IL); HAREL MAZOR, Ramot Menashe (IL); NISREEN AWAD, Nazareth (IL)

(21) Appl. No.: 19/173,234

(22) Filed: Apr. 8, 2025

(51) Int. Cl. G06F 8/73; G06F 11/3668

(52) U.S. Cl. CPC G06F 8/73; G06F 11/3688

(57) ABSTRACT

Methods and systems for managing documentation for software used to provide computer-implemented services are disclosed. An identification of an occurrence of a documentation generation event may be made. Based on the identification, software development elements used to produce the software may be identified, and a user type of the documentation may be identified. Based on the user type, relevant flow data indicating features of the software that are likely to be accessed by the user may be obtained. A portion of available content may be identified from the software development elements (e.g., based on the relevant flow data). A structure for the documentation may be dynamically defined based at least on the portion of the available content and the relevant flow data. The documentation may be automatically generated using the structure and the portion of the available content.

### FIELD

Embodiments disclosed herein relate generally to managing software documentation used to facilitate computer-implemented services. More particularly, embodiments disclosed herein relate to systems and methods for automatic provisioning of the software documentation.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2F show data flow diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing documentation for software used to provide computer-implemented services. For example, downstream consumers of the computer-implemented services may interact with the software to activate features and/or functionality of the software in order obtain the computer-implemented services.

To obtain desired computer-implemented services, the downstream consumers may rely on software documentation (e.g., user manuals and/or other types of documents that include information regarding the features and/or functionality of the software) for guidance in achieving desired outcomes that lead to obtaining the desired computer-implemented services while using the software. For example, without adequate software documentation, a downstream consumer may be unable to obtain the desired computer-implemented services.

However, provisioning of adequate documentation to the downstream consumers in a timely manner may present challenges with respect to resource costs and time limitations. For example, generation of the documentation may require the manual identification, collection, and/or organization of content usable to generate the documentation, as well as orchestrated manual efforts by subject matter experts. Provisioning of the documentation may be further constrained by deadlines (e.g., software testing deadlines, software deployment deadlines).

As a result, the documentation may be inadequate, may negatively impact software development timelines, and/or may not be made available to the downstream consumers timely. For example, to mitigate the resource and/or time constraints, a single version of the documentation may be provided to all users of the software, regardless of different types of users. However, if the documentation is not customized to the different types of users, then the documentation may be subject to information bloat (e.g., the documentation may include excessive amounts of information irrelevant to the user) and/or may be difficult to consume by the user, thereby reducing a likelihood that the user is provided with the desired computer-implemented services.

Thus, to increase a likelihood that different types of users are provided with the desired computer-implemented services, customized versions of the documentation may be generated automatically based on a user type, reducing manual effort and time required to provision (e.g., prepare, supply, deliver) adequate documentation to downstream consumers timely.

The documentation may be generated automatically using pre-existing data used during development of the software. For example, the pre-existing data may include portions of information from software development elements used to produce the software, such as test code, test plans, test run artifacts, production code, and/or others. To generate the documentation, a user type of the documentation may be identified and used to obtain relevant flow data. The relevant flow data may indicate features of the software that are likely to be accessed by a user of the user type. A portion of available content relevant to the user type may be automatically identified from the software development elements and used to populate a document structure. The document structure may be dynamically defined based on the user type in order to customize the software documentation to the user type.

By doing so, the documentation may be more likely to be adequate and easily consumed by different types of downstream consumers, while reducing time and manual effort associated with provisioning of the documentation. As a result, the documentation may be more likely to facilitate provisioning of the desired computer-implemented services to the downstream consumers.

In an embodiment, a method for managing documentation for software used to provide computer-implemented services is provided. The method may include making an identification of an occurrence of a documentation generation event for the software, and based on the identification: identifying software development elements used to produce the software; identifying a user type of the documentation based on information regarding a user of the software as indicated by the occurrence of the documentation generation event; obtaining relevant flow data based on the user type, the relevant flow data indicating features of the software that are likely to be accessed by the user; identifying a portion of available content from the software development elements; dynamically defining, using at least the portion of the available content and the relevant flow data, a structure for the documentation; and, automatically generating the documentation using the structure and the portion of the available content.

The software development elements may include: software development goal information; production code for the software; code development organizational information; test code used to test the software; test plans defining how the software is to be tested; artifacts produced during testing of the software using the test code and the test plans; and, software product integrated organizational information.

The portion of the available content may be identified based on the relevant flow data.

The information regarding the user of the software may include at least one selected from a group consisting of: a job title assigned to the user; a knowledge level of the user; a level of proficiency in the software of the user; an access level associated with the user; a domain of expertise of the user; a preferred language of the user; a software configuration associated with the user; an age of the user; a gender of the user; a culture of the user; and, a characteristic of the user.

Obtaining the relevant flow data may include: obtaining a plurality of user types based on information regarding users of the software; obtaining usage patterns for each of the plurality of user types; and, identifying relevant flow datasets for the plurality of user types based on the usage patterns, wherein the relevant flow data being one of the relevant flow datasets.

The usage patterns may be obtained based on usage data for the users of the software, the usage data including information regarding interactions of the users with respective instances of the software. The respective instances of the software may include a deprecated version of the software.

Dynamically defining the structure may include: obtaining a document skeleton associated with the user type, the document skeleton being adapted to define portions of the structure based on the available content; identifying a portion of organizational information of the available content based on the relevant flow data; and, obtaining, using the document skeleton and the portion of the organizational information, at least one portion of the structure.

A non-transitory media may include instructions that when executed by a processor cause the computer-implemented method to be performed.

A data processing system may include the non-transitory media and a processor, and may perform the computer-implemented method when the computer instructions are executed by the processor.

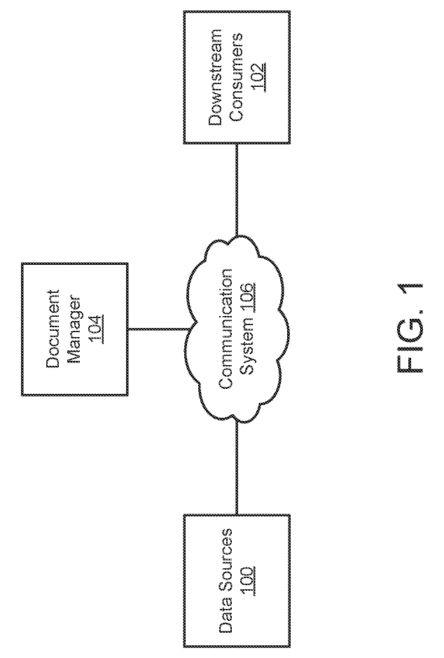

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by data processing systems to downstream consumers of the computer-implemented services (e.g., users of the data processing systems, other data processing systems). For example, users of the data processing systems may operate (e.g., interact with) the data processing systems to obtain the computer-implemented services.

To obtain desired (e.g., expected) computer-implemented services, the users may rely on documentation (e.g., user manuals, troubleshooting instructions, a list of frequently asked questions, administrator guides, videos, walkthroughs, tutorials, etc.) as a guide for operating software components of the data processing systems. Without the documentation, for example, the users of the data processing system may be unable to access desired features and/or functionality of the software, and/or may otherwise be unable to operate the data processing system in a manner that is likely to provide the desired computer-implemented services.

Thus, to increase a likelihood of the data processing systems providing the desired computer-implemented services, documentation for software components of the data processing systems may be provided to downstream consumers of the computer-implemented services.

However, due to limited resources (e.g., time, manual effort, cost) required to generate the documentation, the documentation may be inadequate for facilitating provisioning of the desired computer-implemented services. For example, to manage the limited resources, a single version of the documentation may be provided to all downstream consumers (e.g., users of the software) despite variations in priorities, needs, and/or capabilities of different types of downstream consumers; therefore, the documentation may be inadequate due to information bloat and/or otherwise not being tailored to the different types of downstream consumers.

For example, the documentation may (i) include excessive amounts of irrelevant information to a user (e.g., considering differences in roles (e.g., job titles) and/or access levels of various users), and/or (ii) be difficult to consume by the user (e.g., considering differences in knowledge levels, domains of expertise, and/or other characteristics of users). As a result, downstream consumers of the software may be unable to find and/or consume relevant information within the documentation timely, reducing a likelihood that the downstream consumers be provided with the desired computer-implemented services.

In general, embodiments disclosed herein may provide methods, systems, and/or devices for managing documentation for software used to provide computer-implemented services in a manner that is more likely to result in timely provisioning of desired computer-implemented services. To do so, documentation for the software may be generated automatically based on pre-existing portions of information used during development of the software and a dynamically defined document structure. For example, available content may be identified from software development elements such as test code, test plans, test run artifacts, production code, etc. used to produce the software. The available content may be extracted and transformed to populate the dynamically defined document structure in order to obtain various types of software documentation tailored to various users of the software.

To increase a likelihood of the documentation being adequate for use by different types of downstream consumers, a user type of the documentation may be identified. For example, the user type may include a predefined category assigned to a user to manage the user’s access to features of the software, such as a user role. Based on the user type (e.g., the user role), relevant flow data indicating features of the software that are likely to be accessed by users of the user type may be obtained. The relevant flow data may be used to identify portions of available content most likely to be relevant to the user type, and/or to dynamically define the document structure in order to customize the documentation to the user type.

By automating documentation provisioning to the downstream consumers, manual efforts and time required to generate the documentation may be reduced, while providing for customization of the documentation to various types of users. As a result, the documentation may be more likely to be succinct, relevant to, and easier to consume by a downstream consumer, thereby increasing a likelihood of the different types of downstream consumers being provided with desired computer-implemented services.

To provide the above-mentioned functionality, the distributed system of FIG. 1 may include data sources 100, downstream consumers 102, document manager 104, and communication system 106. The distributed system, any components thereof, and/or any other types of devices or components not shown in FIG. 1 may perform all, or a portion of the computer-implemented services independently and/or cooperatively. Each of these components is discussed below.

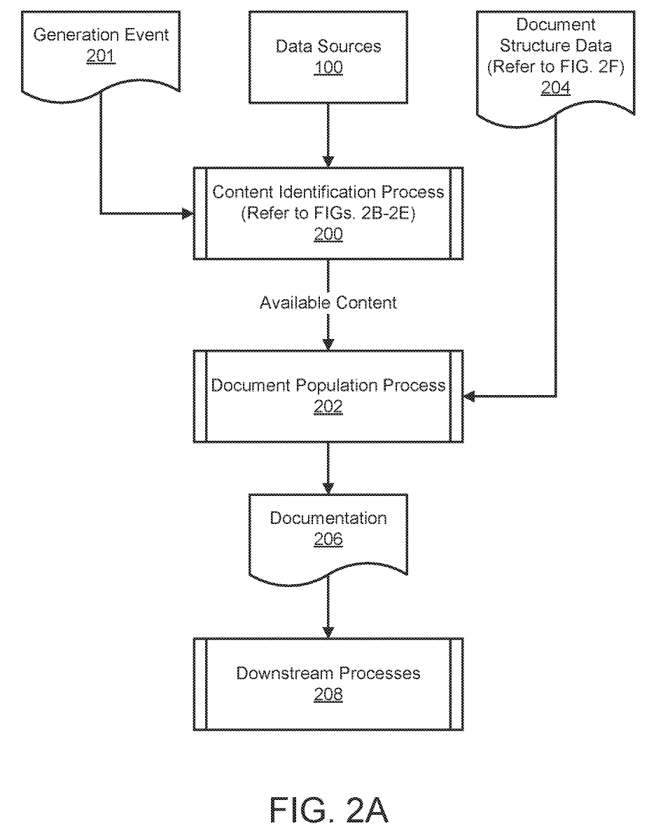

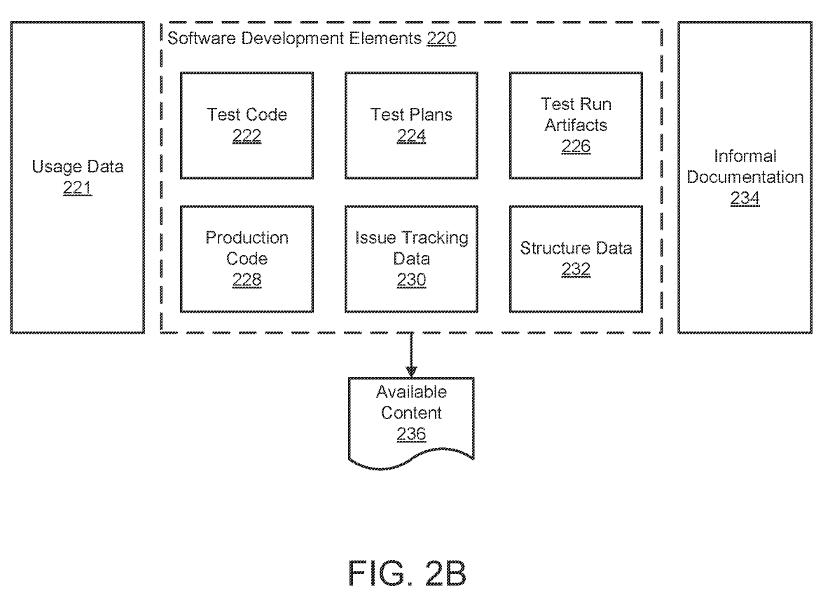

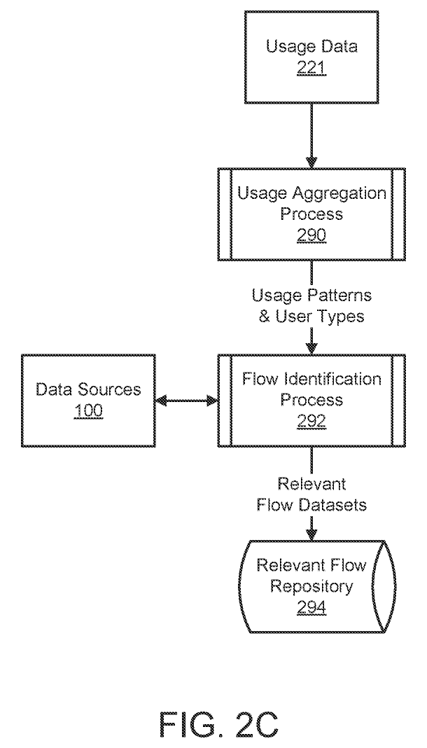

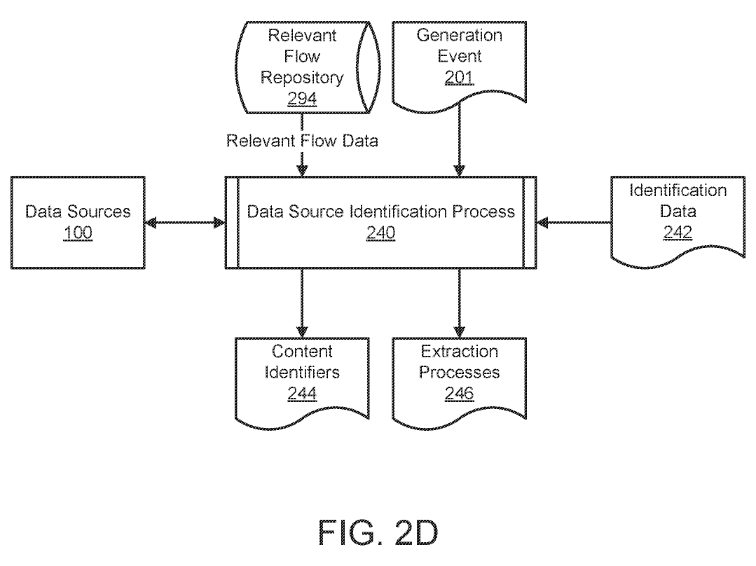

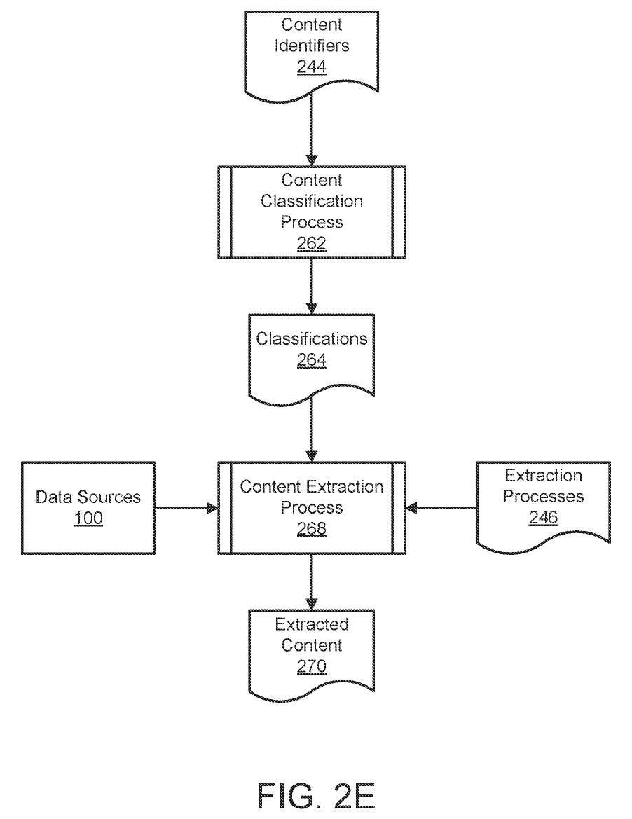

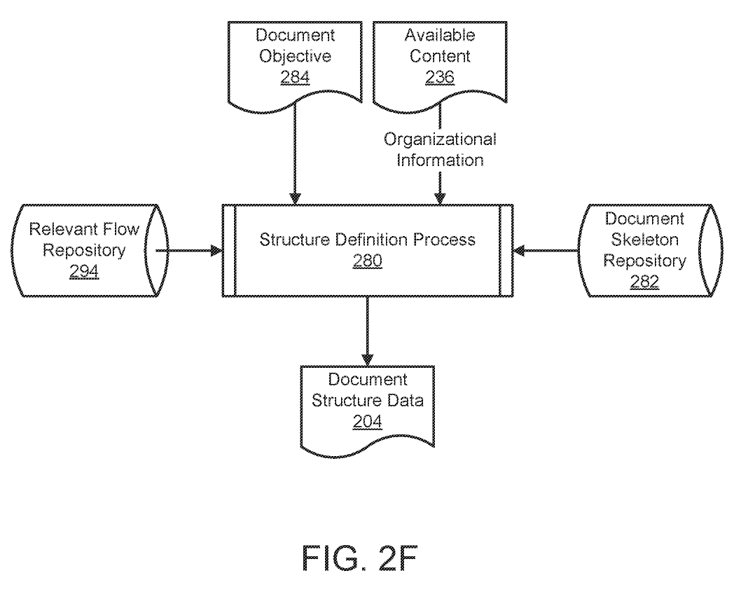

Data sources 100 may include any type and/or number of data sources. Each of data sources 100 may include hardware and/or software components configured to obtain data, store data, provide data to other entities (e.g., document manager 104), and/or to perform any other tasks related to facilitating performance of computer-implemented services. Data sources 100 may include data repositories and/or portions of data (e.g., files, pieces of files). For example, data sources 100 may include (i) information generated during production of and/or used to produce software used by downstream consumers 102 (e.g., software development elements and/or other information), and/or (ii) software usage data (e.g., indicating interactions of different users with respective instances of the software). Refer to the discussion of FIG. 2B for more details regarding data sources 100.

Downstream consumers 102 may include any number and/or type of downstream consumers. For example, downstream consumers 102 may include individuals (e.g., users of data processing systems, administrators of data processing systems), organizations, and/or computers. Downstream consumers 102 may consume all, or a portion of the computer-implemented services. For example, downstream consumers bmay use (e.g., interact with) software to obtain computer-implemented services. Downstream consumers 102 may include different types of users (e.g., defined based on various characteristics of the users) and therefore may rely on customized software documentation in order to obtain the computer-implemented services. Documentation for the software may be managed by document manager 104.

Document manager 104 may include any number of data processing systems and may manage any volume of documentation for any number and/or type of software. Document manager 104 may perform tasks related to the generation, management, and/or provisioning of software documentation. For example, document manager 104 may participate in downstream processes during which the software documentation is provided to and/or used by downstream consumers 102.

To manage the documentation, document manager 104 may make identifications of occurrences of documentation generation events for software. For example, a documentation generation event may be triggered manually or automatically at a certain phase in a development lifecycle of the software. The occurrence of the documentation generation event may indicate, for example, information regarding a user of the software and/or other information usable for generating fit for purpose documentation.

Based on the identified occurrences of the generation events, document manager 104 may (i) identify software development elements used to produce the software, (ii) identify a user type of the documentation (e.g., based on the information regarding the user of the software), (iii) obtain relevant flow data indicating features of the software that are likely to be accessed by the user (e.g., based on the user type), (iv) identify and/or obtain a portion of available content from the software development elements, (v) identify a structure for documentation for the software (e.g., using at least the portion of the available content and the relevant flow data), (vi) automatically generate the documentation using the structure and the portion of the available content (e.g., populating the structure with portions of the available content), and/or (v) perform other actions for provisioning of the documentation to downstream consumers 102. Refer to the discussion of FIG. 2A for more information regarding automatic generation of software documentation using software development elements.

The software development elements may be a portion of information used (e.g., generated) during various phases in a development lifecycle for the software. For example, the software development elements may include (i) software development goal information, (ii) production code for the software, (iii) code development organizational information, (iv) test code used to test the software, (v) test plans defining how the software is to be tested, (vi) artifacts produced during testing of the software using the test code and the test plans, (vii) software product integrated organizational information, (viii) other types of software development elements, and/or (ix) combinations thereof. Refer to FIG. 2B for more details regarding software development elements.

To obtain the relevant flow data, document manager 104 may (i) obtain a plurality of user types based on information regarding users of the software, (ii) obtain usage patterns for each of the plurality of user types, and/or (iii) identify relevant flow datasets for the plurality of user types based on the usage patterns, the relevant flow data being one of the relevant flow datasets. For example, the relevant flow data may be associated with the user type identified by document manager 104 as indicated by the occurrence of the documentation generation event. Refer to FIG. 2C for more details regarding obtaining relevant flow data.

To identify the software development elements used to produce the software, document manager 104 may (i) obtain identification data (e.g., using a manual or automated process) usable to identify at least a portion of the software development elements, (ii) use the identification data and relevant flow data to obtain content identifiers indicating storage locations of information usable to obtain a portion of the available content from the software development elements that is relevant to the user type, and/or (iii) obtain the portion of the available content based on the content identifiers (e.g., using extraction processes corresponding to the content identifiers). Refer to FIG. 2D for more details regarding identification of the software development elements.

To identify and/or obtain the portion of the available content from the software development elements, document manager 104 may (i) obtain classifications for portions of the software development elements (e.g., using the content identifiers), (ii) identify, based on the classifications, at least one extraction process to obtain the portion of the available content stored by the software development elements, and/or (iii) perform the at least one extraction process to obtain the portion of the available content. Refer to FIG. 2E for more details regarding extraction of available content from the software development elements.

To identify the structure for the documentation, document manager 104 may (i) discriminate between portions of the portion of the available content to identify a first portion of the portion of the available content that is classified as organizational information (e.g., from a remaining portion of the portion of the available content that is classified as actionable information), and/or (ii) use the first portion of the portion of the available content, the relevant flow data, and/or other information to dynamically define the structure for the documentation. Refer to FIG. 2F for more details regarding dynamic definition of structures for software documentation.

Document manager 104 may perform any and/or all of the above-mentioned functionality automatically, thereby reducing manual efforts and timelines for provisioning of the software documentation to different types of downstream consumers 102.

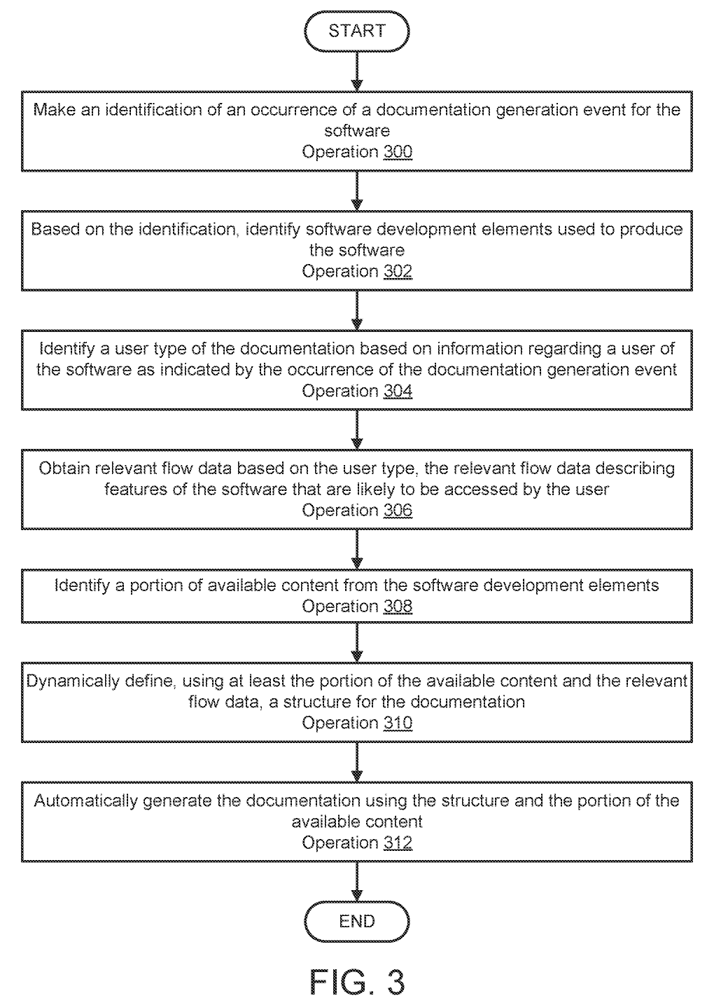

When providing their functionality, any of data sources 100, downstream consumers 102, document manager 104, and/or components thereof may perform all, or a portion of the actions and methods illustrated in FIGS. 2A-3.

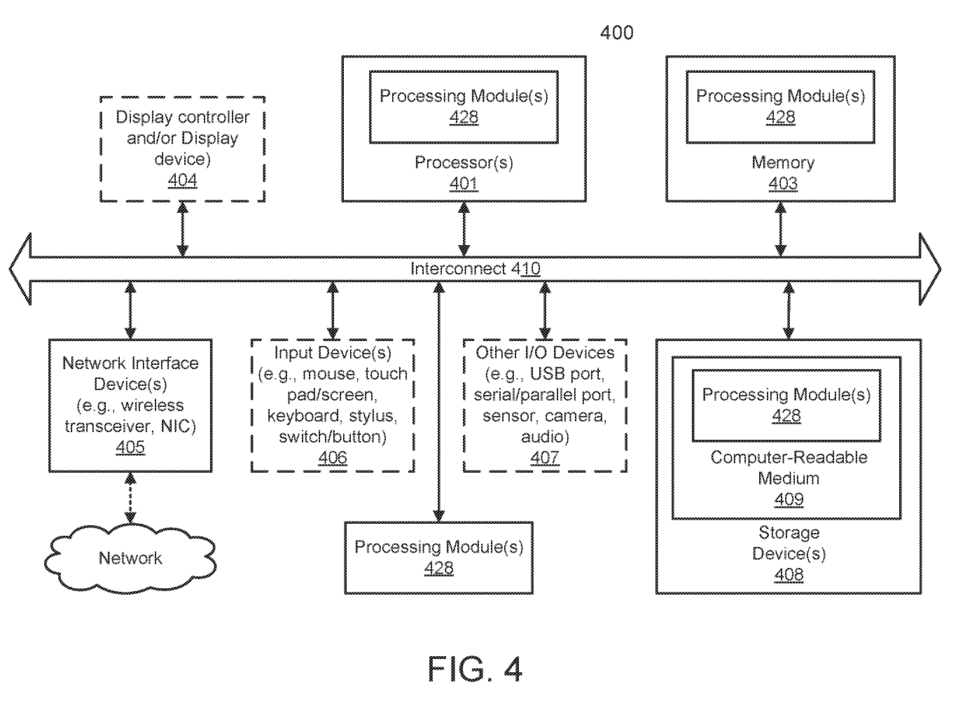

Any of data sources 100, downstream consumers 102, and document manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2F. In the diagrams, flows of data and processing of data are illustrated using different sets of shapes. A first set of shapes (e.g., 201, 204) is used to represent data structures, a second set of shapes (e.g., 200, 202) is used to represent processes performed using and/or that generate data, a third set of shapes (e.g., 282, 294) is used to represent data repositories, and a fourth set of shapes (e.g., 100, 220) is used to represent sources of data.

Turning to FIG. 2A, a first data flow diagram in accordance with an embodiment is shown. The first data flow diagram may illustrate data used in and data processing performed during management of documentation for software used to provide computer-implemented services.

To manage the documentation, a portion of available content from data sources 100 may be obtained during content identification process 200. Content identification process 200 may be initiated based on an occurrence of a documentation generation event for the software. During and/or as a result of the documentation generation event, a data structure such as generation event 201 may be obtained. For example, generation event 201 may include a notification or request provided by an individual, a computer, another entity, and/or other types of data structures that may be automatically generated based on occurrences of documentation generation events.

For example, generation event 201 may include a data structure that is generated automatically during a phase of a development cycle for the software. A management entity (e.g., document manager 104) may identify that generation event 201 has been generated and may provide generation event 201 to content identification process 200. Generation event 201 may include (i) information usable to identify the software, (ii) a document objective (e.g., information regarding a target audience for the documentation, a document type), and/or (iii) other information regarding the documentation.

Generation event 201 may include information regarding an intended user of the documentation. For example, the information regarding the user may include (i) a job title assigned to the user (e.g., a role of the user within an organization), (ii) a domain of expertise of the user, (iii) a knowledge level of the user (e.g., with respect to the domain of expertise of the user, to information technology, and/or other subjects), (iv) a level of proficiency in the software of the user, (v) an access level associated with the user (e.g., access privileges for different features of the software), (vi) a preferred language of the user, (vii) a software configuration associated with the user, (viii) an age of the user, (ix) a gender of the user, (x) a culture of the user, (xi) a characteristic of the user, and/or (xii) a combination thereof.

Portions of the information regarding the user may be, for example, (i) obtained from the intended user of the documentation (e.g., provided and/or confirmed by the intended user), and/or (ii) obtained from another entity (e.g., an automated system, an administrator). The information regarding the user may be used to identify a user type of the documentation. Refer to FIG. 2C for more information regarding user typification.

Content identification process 200 may be performed based on the occurrence of the documentation generation event (e.g., based on information included in generation event 201). During content identification process 200, to obtain content for generating the documentation, a portion of information used during development of the software may be identified from data sources 100. FIG. 2B illustrates an example of data sources 100.

Turning to FIG. 2B, a second data flow diagram in accordance with an embodiment is shown. The second data flow diagram may illustrate information used during various phases of development of software. For example, FIG. 2B may illustrate different types of development artifacts that may be generated during development of and/or during use of the software.

The information may include software development elements 220, usage data 221, and/or informal documentation 234. Software development elements 220 may include test code 222 (e.g., test code used to test the software), test plans 224 (e.g., test plans defining how the software is to be tested), test run artifacts 226 (e.g., artifacts produced during testing of the software using the test code and the test plans), production code 228 (e.g., production code for the software), issue tracking data 230 (e.g., software development goal information), structure data 232 (e.g., code development organizational information, software product integrated organizational information), and/or other information (not shown). For example, software development elements 220 may include a data repository, a directory (e.g., a testing directory), groups of files (e.g., testing documentation within a directory), a file (e.g., an image, a video), and/or portions of files (e.g., portions of test code).

Informal documentation 234 may include any type and/or quantity of informal documentation for software development elements 220, such as developer notes (e.g., readme files), presentations, emails, messages, and/or other information. Information included in informal documentation 234 may not be suitable for use in generating software documentation. For example, informal documentation 234 may include information that is partially incomplete and/or inaccurate with respect to a source of truth (e.g., software development elements 220), and/or informal documentation 234 may include developer interpretations for software development elements 220 that may be uninterpretable by entities outside of a target audience. For example, portions of informal documentation 234 may only be interpretable by software developers due to levels of technicality and/or levels of specificity of the information.

Thus, informal documentation 234 may include information that is not suitable for use in provisioning of the software documentation. However, software development elements 220 may be considered a source of truth, and therefore may include information suitable for use in generating the software documentation. Each of software development elements 220 shown in FIG. 2B is discussed below.

Test code 222 may include different types of test code. For example, test code 222 may include (i) system level test code (e.g., end-to-end level test code, test code usable to automate manual testing that may be performed by a quality assurance engineer), (ii) unit level test code (e.g., test code usable to test an isolated unit of code that supports a single function within the software application with respect to expected behavior), (iii) component level test code (e.g., test code usable to test an isolated component of the software, such as a user interface component), (iv) integration test code (e.g., test code usable to test interactions between parts of the system and emulated parts of the system), and/or (v) combinations thereof.

The different types of test code may include information usable to identify product flows (e.g., tests with positive outcomes), negative tests (e.g., tests with negative outcomes), and/or other information usable to generate software documentation. For example, during software testing, portions of the different types of test code may be executed to obtain images and/or videos that depict use of various features and/or functionality of the software.

For example, the test code may be executed to simulate a flow (e.g., workflow) that is likely to be performed by a user of the software. During the simulation, activity and/or output of the software may be obtained (e.g., the user interface of the software may be recorded and/or otherwise captured). The activity and/or output of the software may include visual information such as images (e.g., screenshots, sequences thereof) and video.

In some examples, the recorded activity and/or output of the software may be processed to improve its interpretability by and/or presentation to the user. In a first example, the test code may be designed to simulate the user flow at high speeds; therefore, videos captured during the simulation may be slowed to speeds fit for human consumption (e.g., walkthrough videos may be slowed more than demonstration videos). Other types of processing of the recorded activity and/or output may be performed. For example, a screenshot of the user interface of the application may be cropped, and text and/or objects may be added to the image to draw user attention to a specific portion of the user interface.

Test code 222 may include test initialization information, assertions used during testing, names of tests (e.g., file names), and/or other information (e.g., code comments that may indicate features and/or functionality being tested). For example, test names and test assertions may be used to identify desired paths of execution (e.g., good paths), undesired paths of execution (e.g., bad paths), workflow steps, preconditions for successfully performing workflows, and/or expected system behavior; and test initialization information may be used to identify system prerequisites and/or steps (e.g., actions) required prior to performing workflows.

Test plans 224 may include any quantity and/or type of test plans. Test plans 224 may include testing schemas used to define the test plans. For example, test plans 224 may include lists of features, functions, and/or workflows to be tested; therefore, information included in test plans 224 may be used to identify main topics and/or to explain workflows.

Test run artifacts 226 may include test reports, test logs, and/or other information produced during testing of the software (e.g., information generated as a result of executing portions of test code 222 and/or as a result of completing portions of test plans 224). For example, test run artifacts 226 may indicate and/or include information regarding successful or unsuccessful test results, video, images, and/or error information.

Production code 228 may include any quantity of code (and/or portions thereof) designed to run on production servers and/or other devices, such as in a browser or a desktop application running on a user device (e.g., client-side code). For example, production code 228 may include information regarding public application programming interfaces (APIs) for the software and/or information regarding intended features and/or functions of the software (e.g., code comments).

Issue tracking data 230 may include any quantity and/or type of data from an issue tracking system (e.g., Jira, GitHub, Azure). For example, issue tracking data 230 may include information regarding software development goals such as epics (e.g., large bodies of performance-related work for a release of the software), user stories (e.g., requirements or feature requests for the software generated from a perspective of the user or downstream consumer), acceptance criteria, known issues (e.g., bugs).

Structure data 232 may include any quantity and/or type of organizational information associated with development of the software. Structure data 232 may include code development organizational information, such as directory (and/or file) hierarchies used to organize portions of the production code and/or portions of the test code during development of the software. For example, code development organizational information may include directory structures, directory names, file names, and/or other storage structural information such as storage (e.g., organizational) relationships between the files and the directories.

Structure data 232 may include software product integrated organizational information such as a user interface menu (e.g., for a graphical user interface, for a command line interface). For example, structure data 232 may include information regarding a structure of the user interface menu such as an arrangement of options and/or commands included in the menu, their relationships and/or dependencies, images (e.g., snapshots of different screens and/or pages of the user interface, icons associated with each menu option and/or command), etc.

Usage data 221 may include any type and/or quantity of information regarding interactions of various users with respective instances of the software. For example, the respective instances of the software may include one or more deprecated versions of the software. Usage data 221 may include, for example, (i) information regarding the users (e.g., user demographics), (ii) information regarding actions performed by the users (e.g., frequency of access to software features and/or software modules by the users), (iii) errors that occurred as a result of the user actions, (iv) types of devices used to access the software, and/or (v) other information that may be collected during software usage tracking. Usage data 221 may be used to obtain different user types (e.g., based on the information regarding the users), and/or usage patterns for the different user types (e.g., based on the information regarding actions performed by the users). The usage patterns may indicate which flows (e.g., features, sequences of features) that the different types of users are likely to access while using the software.

Thus, based on the information included in each of software development elements 220, a portion of information used during development of the software may be used to obtain available content 236. Available content 236 may be a portion of available content stored by software development elements 220 that is likely to be relevant to a user type of the documentation. Thus, available content 236 may include a portion of pre-existing information usable to automatically generate documentation for the software.

Turning to FIG. 2C, a third data flow diagram in accordance with an embodiment is shown. The third data flow diagram may illustrate data used in and data processing performed when obtaining relevant flow data. For example, the relevant flow data may indicate features of software likely to be accessed by a user while using the software.

Any of the processes described with respect to FIG. 2C may, for example, be performed prior to an identification of an occurrence of a documentation generation event being made and/or prior to obtaining a portion of available content (e.g., available content 236) from the software development elements based on the identification of the occurrence of the documentation generation event.

To obtain the relevant flow data, usage aggregation process 290 may be performed. During usage aggregation process 290, usage data 221 may be used to obtain a plurality of user types and usage patterns for each of the plurality of user types. As discussed with respect to FIG. 2B, usage data 221 may include information regarding users of the software, information regarding actions performed by the users while using the software, and/or other information. During usage aggregation process 290, usage data 221 may be aggregated prior to being analyzed. For example, usage data 221 may be collected (e.g., from data sources 100) and/or processed (e.g., filtered, cleaned, reformatted, summarized).

To analyze usage data 221, usage data 221 may be provided as ingest to any number and/or type of inference models. For example, the inference model(s) may be trained to typify users and/or identify usage patterns of the users. For example, the inference model(s) may output the plurality of user types and/or usage patterns that are most likely to be performed by each of the plurality of user types. Any type of analysis (e.g., statistical analysis) may be performed during usage aggregation process 290 to obtain user types and/or usage patterns based on usage data 221.

For example, usage data 221 may be analyzed using a cluster analysis method to establish a set of user types based on portions of the information regarding the users of the software (e.g., job titles, knowledge levels, levels of proficiency in the software, access levels associated with the users, domains of expertise of the users, software configurations associated with the users, ages of the users, genders of the users, cultures of the users, and/or other characteristics of the users).

For each user type, information regarding actions performed by the users and/or other information regarding use of the software by the users may be provided to a pattern recognition algorithm. The pattern recognition algorithm may identify patterns in the use of the software for each user type, and a usage pattern (e.g., a usage pattern identifier) may be assigned to each user type. In some examples, the set of user types may be refined based on the assigned usage patterns. For example, if two different user types of the set of user types have the same (or similar, within a threshold) usage pattern, then the two different user types may be re-classified (e.g., upon re-clustering of the set of user types using the usage pattern as a user characteristic) to establish a refined set of user types. As a result, the two different user types may be combined as a single user type of the refined set of user types.

During usage aggregation process 290, the usage patterns and the user types may be provided to a subsequent process as data structures. The user types data structure(s) may include, for example, (i) user type identifiers, and/or (ii) corresponding characteristics of users of each user type (e.g., a schema for typifying users based on user characteristics). The usage patterns data structure(s) may include, for example, features, devices, configuration settings, errors, and their likelihoods of being relevant to users of different user types with respect to interacting with the software. For example, a first user type may be more likely to use a specific feature or encounter a specific error while using the software than a second user type. The user types and usage patterns may be provided to flow identification process 292.

During flow identification process 292, the usage patterns may be used to identify relevant flow datasets for the plurality of user types from a subset of data sources 100 (e.g., software development elements 220). For example, the relevant flow datasets may include flows (e.g., workflows of the software) associated with features, devices, configuration settings, errors, and/or other information likely (e.g., above a likelihood threshold) to be relevant to users of the different user types.

In a first example, if a usage pattern for a user type indicates that a user of the user type is likely (e.g., above the likelihood threshold) to interact with “software module A” often, then relevant flow data (e.g., of the relevant flow datasets) for the user type may include a list of features of software module A and/or a list of flows associated with software module A. In a second example, if the usage pattern indicates that the user is likely to use “feature A” often, then the relevant flow data for the user type may include a list of features associated with feature A and/or flows associated with feature A.

Thus, during flow identification process 292, relevant flow datasets may be identified. The relevant flow datasets may include, for example, lists of flows, sub-flows, and/or flow steps related to the usage patterns of the user types), and may be identified using information from the software development elements. For example, (i) system level test code may be used to identify system flows associated with the usage patterns, (ii) portions of test code such as test names and/or test assertions may be used to identify flow steps associated with the usage patterns, and/or (iii) test run artifacts such as test reports may be used to identify flows, sub-flows, and/or flow steps associated with the usage patterns.

The relevant flow datasets may be provided to relevant flow repository 294. Relevant flow repository 294 may store and/or manage the relevant flow datasets. Relevant flow repository 294 may include any quantity of relevant flow datasets, each of the relevant flow datasets being associated with different user types (e.g., each user type identified during usage aggregation process 290). Relevant flow repository 294 may include functionality for providing relevant flow data to various processes. For example, a database of relevant flow repository 294 may be queried using a user type identifier and/or other information and the query may return relevant flow data associated with the user type.

The relevant flow data may be used (i) to identify a portion of available content of the software development elements that is relevant to the user type during a data source identification process such as data source identification process 240 of FIG. 2D, and/or (ii) to define a document structure for documentation for the user type during a structure definition process such as structure definition process 280 of FIG. 2F.

Returning to FIG. 2A and continuing the discussion of content identification process 200, to obtain the portion of the available content relevant to a user type (e.g., available content 236), (i) software development elements used to produce the software (e.g., software development elements 220) may be identified from data sources 100, (ii) the portion of the available content may be identified from the software development elements, and/or (iii) the portion of the available content may be extracted from the software development elements. Content identification process 200 may be described in further detail in FIGS. 2D-2E.

Turning to FIG. 2D, a fourth data flow diagram in accordance with an embodiment is shown. The fourth data flow diagram may illustrate data used in and data processing performed when identifying software development elements used to produce software. For example, FIG. 2D may be an expansion of content identification process 200 of FIG. 2A.

To identify the software development elements, data source identification process 240 may be performed. Data source identification process 240 may be initiated based on generation event 201. During data source identification process 240, an entity may be prompted to provide identification data 242 based on information included in generation event 201 (e.g., a software identifier).

For example, the entity may be prompted to provide information regarding software development elements used to produce the software. The entity may include a user and identification data 242 may be obtained based on input from the user, and/or the entity may include a computer and identification data 242 may be automatically generated as part of another process. For example, upon creation of a specific type of file or directory, such as a testing directory, a document policy may be triggered to provide a notification to data source identification process 240.

Identification data 242 may include information usable to identify the software development elements. For example, identification data 242 may include (i) identifiers (e.g., file identifiers, directory identifiers), (ii) instructions for accessing data (e.g., based on the identifiers), and/or (iii) other information (e.g., other instructions and/or cryptographic data usable to access the software development elements). Identification data 242 may be used during data source identification process 240 to identify the software development elements and/or portions thereof from data sources 100.

To identify the software development elements, any number of typification processes may be performed. To do so, data source identification process 240 may access data from and/or provide data to data sources 100. During data source identification process 240, portions of identification data 242 (e.g., identifiers indicating storage locations) may be enumerated to obtain a list of software development elements. For example, the list of software development elements may include a list of file paths and/or directory paths indicated by identification data 242.

Using the list of software development elements, types of the software development elements may be identified. For example, characteristics of portions of available content stored by the software development elements may be obtained. The characteristics of portions of available content may include, for example, (i) directory and/or file names, (ii) file sizes, (iii) file dependencies, (iv) file extension types, (v) file contents (e.g., parsed samples from a header, a footer, and/or a body of a file to identify a format of the file contents), (vi) file metadata, and/or (vii) other measurable or qualitative aspects usable to characterize the portions of available content.

The characteristics of the available content stored by different software development elements may indicate types of the different software development elements, and the types of the software development elements may correspond to phases of a development process for the software. For example, a test code file may have a different file extension type than a test plan file, a test plan file may have a different file content format than an issue tracking data file, and a test run artifact file may have a different file size than a test plan file.

The portions of available content stored by each of the software development elements may be further typified. For example, subtypes of sub-portions of the data may be identified based on the types of the software development elements and characteristics of the sub-portions. The subtypes may indicate different types of available content within each type of software development element. For example, test run artifacts (e.g. a type of software development element) may include subtypes such as test reports and/or test logs.

The available content stored by the software development elements may be typified to any level of detail during data source identification process 240. During data source identification process 240, the types and/or the subtypes may be used to obtain content identifiers 244 and/or extraction processes 246.

Content identifiers 244 may indicate storage locations of information usable to obtain available content from the software development elements. Content identifiers 244 may be defined based on the types and/or the subtypes of the available content. For example, content identifiers 244 may point to the portions of the available content (e.g., defined based on the types) and/or the sub-portions of the available content (e.g., defined based on the subtypes). Content identifiers 244 may include elements such as a directory path, a file path, an offset or byte position within a file, and/or combinations thereof. Content identifiers 244 may include information regarding the types and/or the subtypes of the available content. For example, each of the elements of content identifiers 244 may be tagged with a type, a subtype, and/or other information (e.g., an extraction process identifier).

During data source identification process 240, content identifiers 244 may be limited (e.g., filtered, selected) based on relevant flow data from relevant flow repository 294. To obtain the relevant flow data, a user type of the documentation may be identified based on information included in generation event 201. For example, generation event 201 may include the user type (e.g., a user type identifier) and/or information regarding an (intended) user of the documentation, which may be used to identify the user type (e.g., based on a schema for typifying users). The user type may then be used to obtain the relevant flow data. For example, a user type identifier may be used to query a database managing a repository of relevant flow datasets (e.g., relevant flow repository 294) to obtain relevant flow data for the user type.

The relevant flow data may include flow identifiers, feature identifiers, and/or other information usable to limit content identifiers 244. For example, a user type characterized by a high level of proficiency in the software may require information regarding more features and/or flows than a user type characterized by a low level of proficiency in the software. Therefore, depending on the user type, content identifiers 244 may point to only a portion of the available content (e.g., the portion that is relevant to the user type).

Extraction processes 246 may include any number and/or type of processes for obtaining available content indicated by content identifiers 244. Extraction processes 246 may be identified based on the types and/or the subtypes of the available content of the software development elements. For example, extraction processes 246 may include sets of instructions that correspond to content identifiers 244. In other words, extraction processes 246 may include customized processes for extracting relevant information from the software development elements depending on the type and/or the subtype of the available content.

For example, extraction processes 246 may include scanning processes (e.g., to scan a directory location related to a file or directory path indicated by content identifiers 244) to identify relevant content, parsing processes (e.g., to identify and/or extract portions of files indicated by content identifiers 244), execution processes (e.g., to execute code and/or other processes to capture visual information during user flow simulations), data transformation processes (e.g., for deriving new data based on data indicated by content identifiers 244), and/or storage processes (e.g., for organizing and/or storing extracted content).

In a first example, content identifiers 244 may point to API information included in production code for the software. Extraction processes 246 may include an extraction process that corresponds to a “production code API information” subtype. For example, extraction processes 246 may include instructions for reading the API information from the production code at a specific byte location in a production code file.

In a second example, content identifiers 244 may point to an image included in test run artifacts for the software. Extraction processes 246 may include an extraction process that corresponds to a “test run artifact image” subtype. For example, extraction processes 246 may include instructions for reading the image file, and transforming the image by compressing the image, adding text to the image (e.g., a title, a watermark), updating metadata for the image, etc.

In a third example, content identifiers 244 may point to a portion of test code for the software. Extraction processes 246 may include an execution process to execute the test code, which may simulate a user flow of the software. Extraction processes 246 may also include a recording process to capture video of a user interface of the software during the simulation and/or an image capturing process to capture images of the user interface at various points during the simulation. Extraction processes 246 may include processes for modifying portions (e.g., variables) of the test code in order to customize the user interface during the simulation. For example, system configuration settings, locale settings, modes of operation (e.g., feature flag settings), and/or other settings that impact the user interface may be modified prior to execution of the test code.

Content identifiers 244 and/or extraction processes 246 may be used to obtain the portion of the available content. For example, any number of extraction processes 246 corresponding to (elements of) content identifiers 244 may be performed to obtain portions of the available content. An example of using content identifiers 244 and extraction process 246 to obtain available content is provided with respect to FIG. 2E.

Turning to FIG. 2E, a fifth data flow diagram in accordance with an embodiment is shown. The fifth data flow diagram may illustrate data used in and data processing performed when identifying and/or obtaining available content from software development elements. For example, FIG. 2E may be an expansion of content identification process 200 of FIG. 2A, where a portion of the available content relevant to a user type of the documentation is identified.

To obtain the portion of the available content from the software development elements, a portion of information from content identifiers 244, such as a file identifier (and related information) may be provided to content classification process 262. The file identifier may, for example, indicate a portion of the software development elements. During content classification process 262, one or more classifications for the portion of the software development elements indicated by the file identifier may be obtained (e.g., classifications 264). Classifications 264 may indicate an expected type of content that is to be extracted from data sources 100 using the file identifier, and therefore may be used to identify a suitable extraction process for doing so.

To obtain classifications 264, a type for the portion of the software development elements (e.g., indicated by the file identifier) may be obtained. The type may include a type and/or a subtype (e.g., obtained during data source identification process 240 of FIG. 2D); therefore, the type may be obtained from information related to the file identifier (e.g., data tags, other information included in content identifiers 244). Classifications 264 may be selected based on the type, for example, using a predetermined classification schema.

The classification schema may include, for example, classes for portions of test code such as (i) system test code (e.g., for system level test code), (ii) integration test code (e.g., for integration level test code), (iii) component test code (e.g., for component level test code), (iv) unit test code (e.g., for unit level test code), (v) test initialization information (e.g., for initialization code), (vi) test assertions (e.g., for Boolean-valued functions in the test code), (v) test names (e.g., for test code file names, for portions of header comments in the test code), and/or (vi) other test code classes.

The classification schema may include, for example, classes for portions of software product integrated organizational information (e.g., structure data) such as user interface menus and/or other software product integrated organizational information classes. For example, the user interface menus class may include information such as menu labels, menu options or commands (e.g., indicating functions of the software), and/or other information for guiding user interactions with the software (e.g., hotkeys, menu icons).

The classification schema may include, for example, classes for portions of code development organizational information (e.g., structure data) such as (i) directory names (and/or metadata), (ii) file names (and/or metadata), (iii) storage structure information (e.g., directory and/or file relationships such as hierarchies), and/or (iv) other code development organizational information classes.

The classification schema may include, for example, classes for portions of artifacts produced during testing of the software (e.g., test run artifacts) such as (i) test logs (e.g., for error information, visual information), (ii) test reports (e.g., for results of good or bad tests with supporting visual information), and/or (iii) other test run artifacts classes.

The classification schema may include other classes for other types for the portions of the software development elements.

During content classification process 262, any technique or combination of techniques may be used to obtain classifications 264. In a first example, syntactic analysis techniques (e.g., using natural language processing (NLP) algorithms) may be used to characterize the portion of the software development elements indicated by the file identifier, and classifications 264 may be selected based on the characteristic(s). In a second example, an artificial intelligence model trained to classify portions of software development elements based on content identifiers 244 may be used to obtain classifications 264.

Classifications 264 may include classifications for portions of the software development elements and/or information from content identifiers 244. Classifications 264 may be provided to content extraction process 268 to obtain (e.g., extract) the portion of the available content from data sources 100 (e.g., the software development elements). During content extraction process 268, classifications 264 may be used to identify at least one extraction process of extraction processes 246. For example, extraction processes 246 may be keyed to different classes of portions of the software development elements.

During content extraction process 268, at least one extraction process may be performed to obtain extracted content 270 (e.g., a portion of available content 236). For example, during content extraction process 268, an extraction process suitable for obtaining a portion of available content indicated by classifications 264 may be selected from extraction processes 246 based on classifications 264.

Extraction processes 246 may include modifiable code. For example, during content extraction process 268, portions of code of the selected extraction process may be modified (e.g., code parameters may be populated using information included in classifications 264, such as the file identifier and/or the classification). For example, the selected extraction process may call on different processes for extracting available content based on the populated parameters. The modified code may be executed to obtain extracted content 270.

Any method of extraction may be used during content extraction process 268. For example, extraction processes 246 may include (i) natural language processing algorithms (e.g., syntactic analysis), (ii) large language models (LLM) analysis, and/or (iii) other analysis methods or combinations thereof. Therefore, to perform the at least one extraction process, a prompt may be provided to an inference model (e.g., an LLM, an NLP algorithm, and/or other type of model trained to extract available content) to obtain extracted content 270.

For example, the prompt may be provided to content extraction process 268 by an entity such as a user or a computer. The prompt may include information from classifications 264 (e.g., including content identifiers 244), and/or other information. For example, the prompt may include (i) a task such as, “Summarize topics that were tested in the provided test plan directory.”, and context, such as (ii) the provided test plan directory (e.g., from content identifiers 244), and/or (iii) classifications for information included in the provided directory (e.g., from classifications 264). The inference model may use the prompt to obtain extracted content 270 (e.g., a list of topics) from a subset of data sources 100.

Any portion(s) of the procedure described with respect to FIG. 2E may be repeated until all data sources (e.g., software development elements) indicated by content identifiers 244 are subject to content extraction process 268. Portions of extracted content 270 obtained during each iteration of content extraction process 268 may be packaged as the portion of the available content used for generating documentation for the software (e.g., available content 236 of FIG. 2B, the available content indicated as obtained during content identification process 200 of FIG. 2A).

Returning to FIG. 2A, the portion of the available content may be provided to document population process 202 to obtain documentation 206 (e.g., the software documentation). To perform documentation population process 202, a structure (e.g., defined by document structure data 204) may be identified based at least on the portion of the available content. For example, document structure data 204 may include a document template or a document skeleton and/or may be generated dynamically based on the portion of the available content, information included in generation event 201, and/or other information (e.g., a document objective, relevant flow data). For example, document structure data 204 may be defined based on relevant flow data for a user type of documentation 206 (e.g., the user type may include a beta tester testing a single feature of the software, an administrator that manages the software for a deployment, and/or other types of users for which feature flags may be enabled or disabled); therefore, documentation 206 may be customizable to a high level of detail based on the definition of document structure data 204. Refer to the discussion of FIG. 2F for more details regarding obtaining document structure data.

During documentation population process 202, documentation 206 may be automatically generated using document structure data 204 and the portion of the available content. Consider an example where the portion of the available content includes a testing schema defined by the software development elements (e.g., test plans), results of tests outlined by the testing schema, test code used to execute the tests, etc. The testing schema may define system level testing for the software (e.g., using system level test code), integration testing for the software (e.g., using integration level test code), component testing for the software (e.g., using component level test code), unit testing for the software (e.g., using unit level test code), and/or other types of testing of the software (e.g., API testing, load testing, performance testing).

To obtain documentation 206, sections of documentation 206 may be established based on the testing schema. For example, general functionality of the software may be inferred based on the testing schema and/or other information in the available content, and the sections of documentation 206 may be created corresponding to each type of general functionality. The sections may then be populated using other information included the available content that corresponds to each of the sections (e.g., each type of general functionality), such as specific features or functions indicated by the test results and/or the test code.

Documentation 206 may include any type of documentation that supports the software, such as instructions, general information, and/or other materials. For example, documentation 206 may include any and/or combinations of: user manuals, administrator manuals, troubleshooting manuals, system manuals, initial set up guides, frequently asked questions (FAQs), walkthroughs, tutorials, how-to guides etc. Documentation 206 may include text, images, video, diagrams, and/or other types of information (e.g., referential information such as human interpretable and/or machine-readable links).

Documentation 206 may be provided to downstream processes 208. Downstream processes 208 may include any type of processes related to use of documentation 206 and/or provisioning of documentation 206 to downstream consumers. For example, during downstream processes 208, documentation 206 may be provided to users of the software (e.g., beta testers, regular users, devices, and/or other entities with interest in the software) to facilitate different types of software deployment processes, to facilitate provisioning of computer-implemented services via the software, and/or for use in further developing the software (and/or other software).

Documentation 206 may be customized for use by a target downstream consumer of the software (e.g., based on a user type). Documentation 206 may be customized, in part, based on the dynamic definition of the structure (e.g., document structure data 204).

Turning to FIG. 2F, a sixth data flow diagram in accordance with an embodiment is shown. The sixth data flow diagram may illustrate data used in and data processing performed when dynamically defining a structure for documentation. For example, FIG. 2F may illustrate data used in and data processing performed to obtain document structure data 204 of FIG. 2A.

To obtain the structure (e.g., document structure data 204), structure definition process 280 may be performed. During structure definition process 280, available content classified as organizational information may be obtained from available content 236. To do so, a first portion of available content 236 classified as organizational information may be discriminated from a remaining portion of available content 236 that is classified as actionable information.

For example, portions of available content 236 may be classified during a process similar to content classification process 262 of FIG. 2E, and the portions of available content 236 may include information regarding their classification(s). The classifications may be used to discriminate the first portion from the remaining portion.

The portion of available content 236 classified as organizational information may include, for example, code development organizational information and/or software product integrated organizational information; and the remaining portion of available content 236 classified as actionable information may include, for example, software development goal information, production code for the software, test code used to test the software, test plans defining how the software is to be tested, and/or artifacts produced during testing of the software using the test code and the test plans.

The structure may be dynamically defined based on document objective 284 and/or other information. Document objective 284 may include any type of objective for the documentation. For example, document objective 284 may be included in a data structure obtained based on an occurrence of a documentation generation event such as generation event 201, and/or may be provided to structure definition process 280 as part of other information (e.g., from a user or other entity, as output from another process). Document objective 284 may be based on (e.g., and/or may include) (i) information regarding a user of the documentation (e.g., a user type), (ii) a type of documentation that is to be generated, and/or (iii) other information.

For example, the information regarding the user may be used to identify a user type of the documentation (e.g., using a schema for typifying users). The user type may be used to obtain relevant flow data from relevant flow repository 294 and/or to define portions of document structure data 204. For example, the user type may indicate an access level of the user which may be used to exclude irrelevant features, topics, and/or scenarios from the documentation, and the relevant flow data may indicate relevant features, topics, and/or scenarios that should be included in the documentation.

The type of documentation to be generated may include at least one of, for example, (i) a topic-based document, (ii) a scenario-based document, (iii) a FAQ document, (iv) a trouble-shooting document, and/or (v) other document types. For example, document objective 284 may include a document type identifier.

During structure definition process 280, a document skeleton may be obtained from document skeleton repository 282. Document skeleton repository 282 may include any number and/or type of document skeletons usable to generate documentation. The document skeletons stored by document skeleton repository 282 may be adapted to define portions of the structure based on the organizational information.

Document skeleton repository 282 may include generalized templates for various types of documentation. Therefore, during structure definition process 280, a document skeleton may be selected from document skeleton repository 282 based on the user type (e.g., using a user type identifier), the information regarding the user, and/or other information included in document objective 284. The selected document skeleton may include any number of empty fields intended to be populated with portions of the organizational information and/or information from document objective 284.

For example, if document objective 284 indicates a FAQ document is to be generated, then a document skeleton associated with a FAQ document type may be selected. The selected document skeleton may be generally formatted (e.g., including a cover page, a title, product logos, other information), and may include a defined section for question-and-answer pairs. The defined section for question-and-answer pairs may include a placeholder for more detailed structural information that may be defined using the organizational information. For example, the organizational information may be used to define topic-based subsections for the question-and-answer pairs, an order of the subsections, etc.

The organizational information used to populate placeholders of the document skeleton may be limited based on the relevant flow data. For example, a portion of the organizational information may be selected from available content 236 using flow and/or feature identifiers of the relevant flow data. For example, only organizational information associated with a list of flows, sub-flows, and/or flow steps specified by the relevant flow data may be used to populate the document skeleton. By doing so, sections defined by document structure data 204 may be more likely to be relevant to document objective 284 (e.g., the user type), preventing information bloat.

Thus, during structure definition process 280, the document skeleton may be populated with the (relevant) portion of the organizational information to obtain a portion of the structure (e.g., a portion not already defined by the document skeleton). Information regarding portions of the structure (e.g., the document skeleton populated with portions of the organizational information) may be packaged as document structure data 204. Document structure data 204 may include information regarding a dynamically derived structure for the documentation. Document structure data 204 may be used in subsequent processes (e.g., document population process 202 of FIG. 2A) to obtain the documentation.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using data flows shown in FIGS. 2A-2F, portions of pre-existing information used to produce software may be automatically identified, extracted, and used to populate dynamically defined structures to generate documentation for the software. Selection of the portions of pre-existing information may be constrained based on relevant flow data associated with a user type of the documentation in order to increase a likelihood of the documentation being relevant to and consumable by its intended audience. The documentation may be provided to downstream processes, during which the documentation may be used to facilitate desired computer-implemented services via the software.

By doing so, generation of the documentation may be less likely to require manual effort and/or human intervention, resulting in decreased use of manual resources and decreased time for provisioning of the documentation to downstream consumers.

As discussed above, the components of FIG. 1 may perform various methods to manage documentation for software used to provide computer-implemented services in a manner that improves a quality of the documentation and timely provisioning of the documentation. FIG. 3 illustrates methods that may be performed by the components of FIG. 1. In the diagram discussed below and shown in FIG. 3, any of the operations may be omitted, repeated, performed in different orders, and/or performed in parallel with or in a partially overlapping in time manner with other operations.

Turning to FIG. 3, a flow diagram illustrating a method in accordance with an embodiment is shown. The flow diagram may illustrate various operations performed while managing documentation for software used to provide computer-implemented services.

At operation 300, an identification of an occurrence of a documentation generation event for the software may be made. The identification may be made by (i) reading a data structure (e.g., from storage) indicating the occurrence of the documentation generation event, (ii) receiving a notification indicating the occurrence of the documentation generation event, (iii) obtaining output from an automated process (e.g., initiated based on completion of a phase of a development process for the software), and/or (iv) other methods.

For example, upon completion of a phase of a development process, a data structure including information regarding the documentation generation event (e.g., generation event 201 of FIG. 2A) may be generated and/or provided to a process used in generation of the documentation.

At operation 302, based on the identification, software development elements used to produce the software may be identified. The software development elements may be identified by methods described with respect to content identification process 200 of FIG. 2A, data source identification process 240 of FIG. 2D, and/or by other methods.

For example, the software development elements may be identified by (i) reading a data structure (e.g., from storage) including information usable to identify the software development elements, (ii) receiving a notification including information usable to identify the software development elements, (iii) providing a notification indicating the occurrence of the documentation generation event to an entity responsible for identifying the software development elements, and/or (iv) scanning a known (e.g., trusted) data source that stores information used during development of the software for available content based on input from a user, a process, and/or a device.

At operation 304, a user type of the documentation may be identified based on information regarding a user of the software as indicated by the occurrence of the documentation generation event. The user type may be identified by methods described with respect to usage aggregation process 290 of FIG. 2C and/or by other methods.

For example, the user type may be identified by (i) reading a data structure (e.g., from storage) indicating the user type, (ii) receiving a notification indicating the user type, (iii) providing the information regarding the user to an entity (e.g., a program, a service) responsible for identifying user types based on information regarding users, and receiving the user type as a response from the entity, and/or (iv) using a schema for typifying users to obtain the user type (e.g., based on a comparison of user characteristics included in the information regarding the user and characteristics defined by the schema).

At operation 306, relevant flow data may be obtained based on the user type, the relevant flow data indicating features of the software that are likely to be accessed by the user. The relevant flow data may be obtained by (i) reading the relevant flow data (e.g., from storage, from a relevant flow repository), (ii) receiving the relevant flow data (e.g., from a device), and/or (iii) generating the relevant flow data. For example, the relevant flow data may be generated by methods described with respect to flow identification process 292 of FIG. 2C and/or by other methods.

Obtaining the relevant flow data may include (i) obtaining a plurality of user types based on information regarding users of the software, (ii) obtaining usage patterns for each of the plurality of user types, and (iii) identifying relevant flow datasets for the plurality of user types based on the usage patterns, wherein the relevant flow data being one of the relevant flow datasets.

The plurality of user types may be obtained by (i) reading the plurality of user types (e.g., from storage), (ii) receiving the plurality of user types (e.g., from a device), and/or (iii) generating the plurality of user types. For example, the plurality of user types may be generated by analyzing aspects of use of the software by a plurality of users (e.g., analyzing usage data for the software).

The usage patterns may be obtained by (i) reading the usage patterns (e.g., from storage), (ii) receiving the usage patterns (e.g., from a device), and/or (iii) generating the usage patterns. For example, the usage patterns may be generated by providing usage data for the software to an entity responsible for identifying patterns in data (e.g., a service, an inference model, an algorithm), and receiving the usage patterns as a response from the entity.

The relevant flow datasets may be identified by (i) reading a data structure (e.g., from storage) indicating the relevant flow datasets, (ii) receiving a notification indicating the storage location of the relevant flow datasets, (iii) providing usage patterns for different user types to an entity (e.g., a service, an inference model, an algorithms) that identifies software flows (e.g., sub-flows, flow steps, features) associated with the usage patterns, and receiving relevant flow data for each of the different user types as a response from the entity.

At operation 308, a portion of available content may be identified from the software development elements. The portion of the available content may be identified by methods described with respect to content classification process 262 of FIG. 2E and/or by other methods. For example, the portion of the available content may be identified by (i) reading a data structure (e.g., from storage) indicating information usable to identify the portion of the available content, (ii) receiving a notification indicating information usable to identify the portion of the available content, (iii) receiving the portion of the available content, and/or (iv) characterizing and/or classifying data stored by (or as) the software development elements, and using the characterizations and/or classifications to identify and/or obtain the portion of the available content.

The portion of the available content may include available content stored by the software development elements that is relevant to the user type. Therefore, the portion of the available content may be identified by using the relevant flow data to filter available content stored by the software development elements.

At operation 310, a structure for the documentation may be dynamically defined using at least the portion of the available content and the relevant flow data. The structure may be dynamically defined by methods described with respect to structure definition process 280 and/or by other methods. The structure may be dynamically defined based on an objective (e.g., a user type, a document type) for the documentation.

For example, the structure may be dynamically defined by (i) obtaining a document skeleton associated with the user type, the document skeleton being adapted to define portions of the structure based on the portion of the available content, (ii) identifying a portion of organizational information of the portion of the available content based on the relevant flow data, and (iii) obtaining, using the document skeleton and the portion of the organizational information, at least one portion of the structure.

The document skeleton may be obtained by (i) receiving the document skeleton (e.g. from a device), (ii) reading the document skeleton (e.g., from storage), and/or (iii) generating the document skeleton. For example, the document skeleton may be generated by (i) modifying old versions of the document skeleton, and/or (ii) manually designing the skeleton (e.g., by a subject matter expert).

The document skeleton may be obtained, for example, by providing the user type and/or other information included in the objective (e.g., the document type) to a lookup process to identify the document skeleton corresponding to the user type and/or the other information (e.g., from a document skeleton repository).

The portion of the organizational information may be identified by (i) reading a data structure indicating storage locations of the portion of the organizational information, (ii) receiving a notification indicating storage locations of the portion of the organizational information, (iii) obtaining the portion of the organizational information, (iv) discriminating organizational information from actionable information of available content of the software development elements, and/or (v) filtering the organizational information based on the relevant flow data using a search method (e.g., a keyword search or similarity search of metadata and/or data tags) to obtain the portion of the organizational information associated with the relevant flow data.

The at least one portion of the structure may be obtained by (i) receiving the at least one portion of the structure (e.g. from a device) (ii) reading the at least one portion of the structure (e.g., from storage), and/or (iii) generating the at least one portion of the structure. For example, the at least one portion of the structure may be generated by using information from the portion of the organizational information to populate portions of the structure defined by the document skeleton (e.g., the document skeleton may define sections of the structure, and the portion of the organizational information may define subsections of the sections).

At operation 312, the documentation may be automatically generated using the structure and the portion of the available content. The documentation may be automatically generated using methods described with respect to document population process 202 and/or by other methods. For example, the portion of the available content and the structure may be provided to an inference model trained to generate the documentation based on available content and a structure and/or by other methods that do not require manual intervention by a subject matter expert.

The documentation may be generated by (i) establishing a first plurality of sections of the documentation based on a testing schema defined by the software development elements, (ii) populating the first plurality of sections using, at least, test results extracted from the software development elements, (iii) inferring, based on the testing schema, functions of the software, (iv) creating sections of the first plurality of sections corresponding to the functions, and/or (v) other methods.

The first plurality of sections may be established by (i) obtaining a data structure indicating the sections that are to be established, (ii) identifying scenarios and/or topics tested using the testing schema (e.g., test plans of the software development elements), (iii) populating the documentation with the tested scenarios and/or topics as the first plurality of sections, and/or (iv) generating empty fields (e.g., defining placeholders) for each of the first plurality of sections for population with other information.

The first plurality of sections may be populated by (i) identifying results of the tested scenarios and/or topics from test run artifacts (e.g., test reports, test logs) of the software development elements, (ii) extracting the identified test results from the software development elements, and/or (iii) using the test results to fill the empty fields of each of the first plurality of sections.

The functions of the software may be inferred by (i) identifying functions tested using the testing schema (e.g., test plans of the software development elements), (ii) treating the tested functions as the functions of the software, and/or (iii) providing the testing schema to an inference model trained to infer functions of the software from at least the testing schema.

Sections of the first plurality of sections may be created by (i) obtaining a list of inferred functions of the software, (ii) using the list of the inferred functions of the software to populate placeholders in each section of the first plurality of sections. For example, the sections may include the tested topics and/or scenarios, and the subsections may include information regarding functions or features associated with each of the tested topics and/or scenarios.

The method may end following operation 312.

Thus, as illustrated above, embodiments disclosed herein may provide systems and methods for managing automated generation of documentation for software used to provide computer-implemented services. The systems and methods may facilitate the automated generation of the documentation using pre-existing information from software development elements used to produce the software, without requiring human intervention. By automatically identifying and extracting portions of the pre-existing information that are relevant to a target audience (e.g., a user type) of the documentation, manual generation of new content and customized documentation may not be required, reducing time and manual effort expended during the documentation generation process.

By using relevant portions of the pre-existing information to dynamically define and populate a structure for the documentation, the documentation may be automatically customized to a target audience, increasing a likelihood of the documentation being effective in facilitating the computer-implemented services.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing documentation for software used to provide computer-implemented services, the method comprising:
making an identification of an occurrence of a documentation generation event for the software; and
based on the identification:
identifying software development elements used to produce the software,
identifying a user type of the documentation based on information regarding a user of the software as indicated by the occurrence of the documentation generation event,
obtaining relevant flow data based on the user type, the relevant flow data indicating features of the software that are likely to be accessed by the user,
identifying a portion of available content from the software development elements,
dynamically defining, using at least the portion of the available content and the relevant flow data, a structure for the documentation, and
automatically generating the documentation using the structure and the portion of the available content.

2. The method of claim 1, wherein the software development elements comprise:
software development goal information;
production code for the software;
code development organizational information;
test code used to test the software;
test plans defining how the software is to be tested;
artifacts produced during testing of the software using the test code and the test plans; and
software product integrated organizational information.

3. The method of claim 1, wherein the portion of the available content is identified based on the relevant flow data.

4. The method of claim 1, wherein the information regarding the user of the software comprises at least one selected from a group consisting of:
a job title assigned to the user;
a knowledge level of the user;
a level of proficiency in the software of the user;
an access level associated with the user;
a domain of expertise of the user;
a preferred language of the user;
a software configuration associated with the user;
an age of the user;
a gender of the user;
a culture of the user; and
a characteristic of the user.

5. The method of claim 1, wherein obtaining the relevant flow data comprises:
obtaining a plurality of user types based on information regarding users of the software;
obtaining usage patterns for each of the plurality of user types; and
identifying relevant flow datasets for the plurality of user types based on the usage patterns, wherein the relevant flow data being one of the relevant flow datasets.

6. The method of claim 5, wherein the usage patterns are obtained based on usage data for the users of the software, the usage data comprising information regarding interactions of the users with respective instances of the software.

7. The method of claim 6, wherein the respective instances of the software comprise a deprecated version of the software.

8. The method of claim 1, wherein dynamically defining the structure comprises:
obtaining a document skeleton associated with the user type, the document skeleton being adapted to define portions of the structure based on the available content;
identifying a portion of organizational information of the available content based on the relevant flow data; and
obtaining, using the document skeleton and the portion of the organizational information, at least one portion of the structure.

9. A non-transitory machine-readable medium having instructions stored therein, which when executed by a processor, cause the processor to perform operations for managing documentation for software used to provide computer-implemented services, the operations comprising:
making an identification of an occurrence of a documentation generation event for the software; and
based on the identification:
identifying software development elements used to produce the software,
identifying a user type of the documentation based on information regarding a user of the software as indicated by the occurrence of the documentation generation event,
obtaining relevant flow data based on the user type, the relevant flow data indicating features of the software that are likely to be accessed by the user,
identifying a portion of available content from the software development elements,
dynamically defining, using at least the portion of the available content and the relevant flow data, a structure for the documentation, and
automatically generating the documentation using the structure and the portion of the available content.

10. The non-transitory machine-readable medium of claim 9, wherein the software development elements comprise:
software development goal information;
production code for the software;
code development organizational information;
test code used to test the software;
test plans defining how the software is to be tested;
artifacts produced during testing of the software using the test code and the test plans; and
software product integrated organizational information.

11. The non-transitory machine-readable medium of claim 9, wherein the portion of the available content is identified based on the relevant flow data.

12. The non-transitory machine-readable medium of claim 9, wherein the information regarding the user of the software comprises at least one selected from a group consisting of:
a job title assigned to the user;
a knowledge level of the user;
a level of proficiency in the software of the user;
an access level associated with the user;
a domain of expertise of the user;
a preferred language of the user;
a software configuration associated with the user;
an age of the user;
a gender of the user;
a culture of the user; and
a characteristic of the user.

13. The non-transitory machine-readable medium of claim 9, wherein obtaining the relevant flow data comprises:
obtaining a plurality of user types based on information regarding users of the software;
obtaining usage patterns for each of the plurality of user types; and
identifying relevant flow datasets for the plurality of user types based on the usage patterns, wherein the relevant flow data being one of the relevant flow datasets.

14. The non-transitory machine-readable medium of claim 13, wherein the usage patterns are obtained based on usage data for the users of the software, the usage data comprising information regarding interactions of the users with respective instances of the software.

15. A data processing system, comprising:
a processor; and
a memory coupled to the processor to store instructions, which when executed by the processor, cause operations for managing documentation for software used to provide computer-implemented services to be performed, the operations comprising:
making an identification of an occurrence of a documentation generation event for the software, and
based on the identification:
identifying software development elements used to produce the software,
identifying a user type of the documentation based on information regarding a user of the software as indicated by the occurrence of the documentation generation event;
obtaining relevant flow data based on the user type, the relevant flow data indicating features of the software that are likely to be accessed by the user;
identifying a portion of available content from the software development elements;
dynamically defining, using at least the portion of the available content and the relevant flow data, a structure for the documentation; and
automatically generating the documentation using the structure and the portion of the available content.

16. The data processing system of claim 15, wherein the software development elements comprise:
software development goal information;
production code for the software;
code development organizational information;
test code used to test the software;
test plans defining how the software is to be tested;
artifacts produced during testing of the software using the test code and the test plans; and
software product integrated organizational information.

17. The data processing system of claim 15, wherein the portion of the available content is identified based on the relevant flow data.

18. The data processing system of claim 15, wherein the information regarding the user of the software comprises at least one selected from a group consisting of:
a job title assigned to the user;
a knowledge level of the user;
a level of proficiency in the software of the user;
an access level associated with the user;
a domain of expertise of the user;
a preferred language of the user;
a software configuration associated with the user;
an age of the user;
a gender of the user;
a culture of the user; and
a characteristic of the user.

19. The data processing system of claim 15, wherein obtaining the relevant flow data comprises:
obtaining a plurality of user types based on information regarding users of the software;
obtaining usage patterns for each of the plurality of user types; and
identifying relevant flow datasets for the plurality of user types based on the usage patterns, wherein the relevant flow data being one of the relevant flow datasets.

20. The data processing system of claim 19, wherein the usage patterns are obtained based on usage data for the users of the software, the usage data comprising information regarding interactions of the users with respective instances of the software.
